(19) United States
(12) Patent Application Publication
(10) Pub. No.: US 2024/0241281 A1
(43) Pub. Date: Jul. 18, 2024

(54) METHOD AND SYSTEM FOR DEEP LEARNING FOR SEISMIC INTERPRETATION

(71) Applicant: ExxonMobil Technology and Engineering Company, Spring, TX (US)

(72) Inventors: Jacquelyn S. Daves, Houston, TX (US); Cody J. MacDonald, Houston, TX (US); Hayden A. Powers, Houston, TX (US)

(73) Assignee: ExxonMobil Technology and Engineering Company, Spring, TX (US)

(21) Appl. No.: 18/411,797

(22) Filed: Jan. 12, 2024

Related U.S. Application Data
(60) Provisional application No. 63/439,428, filed on Jan. 17, 2023.

(51) Int. Cl. G01V 1/50; G06T 17/05

(52) U.S. Cl. CPC G01V 1/50; G06T 17/05

(57) ABSTRACT

A method and a system for generating one or more initial geologic models for hydrocarbon management or carbon capture sequestration is disclosed. The initial geologic models may be generated that describe distribution of AVO (Amplitude-Variation-with-Offset) behaviors of one or more subsurface features, such as sands or rock types, into one or more probability volumes, resulting in a dimensionality reduction of information. The initial geologic models may be used in a variety of contexts, such as for geologic interpretation or as prior information for input to a seismic inversion process.

### REFERENCE TO RELATED APPLICATION

The present application claims priority to U.S. Provisional Application No. 63/439,428, which is incorporated by reference herein in its entirety.

### FIELD OF THE INVENTION

The present application relates generally to the field of hydrocarbon exploration, development and production. Specifically, the disclosure relates to a methodology and framework for machine learning capturing AVO and geometric relationships.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An important goal of geophysical prospecting is to accurately image subsurface structures to assist in the identification and/or characterization of hydrocarbon-bearing formations. Geophysical prospecting may employ a variety of data-acquisition techniques, including seismic prospecting, electromagnetic prospecting, well logging, etc. Such data may be processed, analyzed, and/or examined with a goal of identifying geological structures that may contain hydrocarbons.

Geophysical data (e.g., acquired seismic data) and/or reservoir surveillance data (e.g., well logs) may be analyzed to develop subsurface models (e.g., models of geology, including rock types). For example, one or more inversion procedures may be utilized to analyze the geophysical data and produce models of rock properties and/or fluid properties. Generally, inversion is a procedure that finds a parameter model, or collection of models, which, through simulation of some physical response to those parameters, can reproduce to a chosen degree of fidelity a set of measured data. Inversion may be performed, for example, on seismic data to derive a model of the distribution of elastic-wave velocities within the subsurface of the earth. Parameterization of a subsurface model (e.g., by uniform discretization) may utilize many volume elements (voxels) of uniform elastic-wave velocities to match simulated data to the observed seismic data.

Non-uniqueness is a pervasive feature of geophysical inversion problems. Geophysical surveys typically acquire data at locations remote from the subsurface region of interest (e.g., at the surface of the earth or a body of water) and at narrow frequency bands (e.g., from about 3 Hz to about 60 Hz) due to the physical limitations of the survey (e.g., to generate lower frequencies, impractically large sources may be utilized, while mechanical loss and wavefield scattering tend to attenuate seismic waves at higher frequencies). These limitations lead to incomplete information and large uncertainty about the subsurface region of interest.

Moreover, petrophysical inversion generally transforms elastic parameters, such as seismic velocity and density, to petrophysical parameters, such as porosity and volume of clay (V_{clay}). For example, petrophysical inversion can transform compressional velocity, shear velocity, and density well logs to porosity and/or V_{clay} logs. As another example, petrophysical inversion may utilize elastic information from seismic data, including traditional images of reflectivity and tomographic velocity, to predict three-dimensional volumes of porosity and V_{clay}. (Elastic information may be determined from seismic data by any suitable means, including in some cases by seismic inversion to solve for an elastic or similar geophysical properties model based on input seismic data.) As used herein, V_{clay} refers to rock volumes including anything that is not sand (e.g., shale). That is, clay and shale (and associated properties such as V_{clay} and Vₛₕₐₗₑ) are treated interchangeably with the recognition that they are not strictly the same from a mineralogical standpoint. Furthermore, petrophysical inversion may include other geophysical data types, such as electromagnetic data or resistivity, which tend to have a better sensitivity to water saturation than elastic parameters. Although petrophysical inversion may be performed with input elastic information or elastic parameters (which may, as noted, be determined from seismic data via, e.g., seismic inversion), or performed with input electromagnetic data or resistivity as just noted, in some cases petrophysical inversion may be used to determine petrophysical parameters from input seismic data. In such a case, the petrophysical inversion may be referred to as an “integrated petrophysical inversion” insofar as it encompasses inversion sometimes associated with seismic inversion processes (e.g., determining elastic parameters from seismic data).

In practice, the inversion process may receive one or more inputs, such as data (e.g., seismic data) and prior models. Prior models (or priors) may include geological information that was available prior to the solution was formed and may be input to the inversion process. Examples are illustrated in US Patent Application Publication No. 2021/0041596 A1 and US Patent Application Publication No. 2023-0032044, both of which are incorporated by reference herein in their entirety. The priors may comprise an initial estimate for one or more parameters subject to inversion. For example, the initial petrophysical parameter estimate may comprise a model of porosity and/or V_{clay}. The inversion process may then use the priors in order to the geological inversion.

### SUMMARY OF THE INVENTION

In one or some embodiments, a computer-implemented method of performing geophysical investigation is disclosed. The method includes: (a) performing data preparation for one or more potential subsurface models by identifying one or more seismic volumes in determining one or more aspects of one or more reservoirs; (b) analyzing the one or more potential subsurface models for expected or desired results; (c) responsive to determining that the one or more potential subsurface models do not yield the expected or the desired results, performing one or both of: generating additional labels or additional labeled examples; or performing additional machine learning, after which reverting to at least one of (a) or (b); (d) using the one or more potential subsurface models to batch predict part or all of the one or more reservoirs; (e) determining whether the batch prediction of the part or all of the one or more reservoirs is within a predetermined tolerance of well data or predetermined interpretation need; (f) responsive to determining that the batch prediction of the part or all of the reservoir is not within the predetermined tolerance of the well data or the predetermined interpretation need, revert to at least one of (a) or (b); and (g) responsive to determining that the batch prediction of the part or all of the reservoir is within the predetermined tolerance of the well data or the predetermined interpretation need, using the batch prediction for hydrocarbon management or carbon capture sequestration (CCS) management.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 illustrates a block diagram for data preparation, training, and prediction and interpretation.

FIG. 2 is a flow diagram for training and using models.

FIG. 3 are illustrations of stratigraphic segmentations and fault predictions.

FIGS. 4A-C are illustrations of outputs of trained AVO classification networks including AVO class strength (FIG. 4A), off-trend AVO (FIG. 4B), and anomalous AVO (FIG. 4C).

FIG. 5 is a block diagram of data and model governance.

FIG. 6 is a block diagram of machine learning augmented modeling and inversion.

FIG. 7 illustrates a synthetic example in which the generative modeling and inversion process was performed to invert for acoustic impedance and Vp/Vs ratio using various stack angles.

FIG. 8 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (e.g., acoustic) data sets in conjunction with other geophysical data, including, for example, gravity plus seismic; gravity plus electromagnetic plus seismic data, etc. For example, joint-inversion utilizes multiple geophysical data types.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

The term “geological features” (interchangeably termed geo-features) as used herein broadly includes attributes associated with a subsurface, such as any one, any combination, or all of: subsurface geological structures (e.g., channels, volcanos, salt bodies, geological bodies, geological layers, etc.); boundaries between subsurface geological structures (e.g., a boundary between geological layers or formations, etc.); or structure details about a subsurface formation (e.g., subsurface horizons, subsurface faults, mineral deposits, bright spots, salt welds, distributions or proportions of geological features (e.g., lithotype proportions, facies relationships, distribution of petrophysical properties within a defined depositional facies), etc.). In this regard, geological features may include one or more subsurface features, such as subsurface fluid features, which may be hydrocarbon indicators (e.g., Direct Hydrocarbon Indicator (DHI)). Examples of geological features include, without limitation salt, fault, channel, environment of deposition (EoD), facies, carbonate, rock types (e.g., sand and shale), horizon, stratigraphy, or geological time, and are disclosed in US Patent Application Publication No. 2010/0186950 A1, incorporated by reference herein in its entirety. In this regard, the one or more potential subsurface models may be representative of assumed or known aspects of the subsurface, such as any one, any combination, or all of: rock types; architectures; features; or facies.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) may be represented by picture elements (pixels). Such numerical representations may be shape-based or functional forms in addition to, or in lieu of, cell-based numerical representations.

The term “subsurface model” as used herein refer to a numerical, spatial representation of a specified region or properties in the subsurface.

The term “geologic model” as used herein refer to a subsurface model that is aligned with specified geological feature such as faults and specified horizons.

The term “reservoir model” as used herein refer to a geologic model where a plurality of locations have assigned properties including any one, any combination, or all of rock type, EoD, subtypes of EoD (sub-EoD), porosity, clay volume, permeability, fluid saturations, etc.

For the purpose of the present disclosure, subsurface model, geologic model, and reservoir model are used interchangeably unless denoted otherwise.

Stratigraphic model is a spatial representation of the sequences of sediment, formations and rocks (rock types) in the subsurface. Stratigraphic model may also describe the depositional time or age of formations.

Structural model or framework results from structural analysis of reservoir or geobody based on the interpretation of 2D or 3D seismic images. For examples, the reservoir framework comprises horizons, faults and surfaces inferred from seismic at a reservoir section.

As used herein, “hydrocarbon management” or “managing hydrocarbons” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted overtime), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, carbon capture sequestration (CCS) (also known as carbon sequestration) may comprise a process of capturing and/or storing carbon dioxide (such as atmospheric carbon dioxide). An example of CCS may comprise geologic carbon sequestration whereby carbon dioxide is stored in underground geologic formations. The carbon dioxide may be pressurized until it becomes a liquid, and then may be injected into porous rock formations in geologic basins. In one or some embodiments, this method of carbon storage may be a part of enhanced oil recovery (EOR) in that the carbon dioxide may be used later in the life of a producing oil well (e.g., after the primary depletion stage). In particular, in EOR, the liquid carbon dioxide may be injected into the oil-bearing formation in order to reduce the viscosity of the oil, thereby allowing the oil to flow more easily to the oil well. See U.S. Pat. No. 11,083,994, incorporated by reference herein in its entirety.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, the energy industry typically spends considerable resources acquiring and processing seismic data. This data may then be used to peer into the subsurface and is fundamental to hydrocarbon exploration and production. However, many of the ways in which the data is analyzed have been stuck in manual paradigms for a number of years, despite numerous advancements in automation, such as waveform tracking and globally optimized correlation based interpretation. For certain applications, such as for horizon objects in a dataset, these manual-based methods may be sufficient. However, in other cases, such as faults, salt, unconformities, and other complex features and relationships, these methods may be insufficient. As discussed further below, in one or some embodiments, the methodology disclosed may perform any one, any combination, or all of: reducing the cycle time for outstanding seismic interpretation activities, allowing for the formal collection of examples to inform and automate future analyses, and augmenting broad integration practices.

Further, as discussed in the background, non-uniqueness may be a pervasive feature of geophysical inversion problems. For example, AVO (Amplitude-Variation-with-Offset) is one such data collecting methodology that is a relative interface property and is dependent on local geology and stacking patterns, giving rise to non-unique and varying responses laterally and vertically. See, for example, US Patent Application Publication No. 2003/0046006 and U.S. Pat. No. 8,706,420, both of which are incorporated by reference herein in their entirety. Furthermore, seismic imaging often does not yield perfect representations and recovery of these properties. Incorrect positioning and incomplete correction of transmission losses can cause distortions and variability.

Fluid prediction via AVO analysis may be used for risk reduction in the exploration, development and production of hydrocarbon resources. AVO analysis recognizes that the seismic reflection amplitude may vary with change in distance between the seismic source and receiver, where the offset is the distance between the seismic source and the receiver. Specifically, the variation in seismic reflection amplitude may be indicative of differences in lithology and fluid content in the subsurface rock layers. For example, AVO analysis may be used to determine thickness, porosity, density, velocity, lithology and fluid content of rock layers. A seismic reflection amplitude from a low-impedance, hydrocarbon-bearing sand typically increases with increasing offset distance. However, various rocks and fluids have different reflection amplitudes versus offsets indicative of the specific rock and fluid composition, e.g., various increasing amplitude with offset or decreasing amplitude with offset depending on the type of rock or fluid present. The accurate seismic prediction of fluids may be used in resource exploration and, more specifically, used as a tool to aid in understanding the lithology and porosity of the rock.

In one or some embodiments, AVO may refer to the variation of P-wave amplitude at increasing shot-to-receiver offset or reflection angle. When rock formations are flat and isotropic (in which isotropic may mean that elastic properties of the medium do not change regardless of the directions in which they are measured), reflection amplitude at a fixed offset does not change with the azimuth (direction angle of the shot-to-receiver line measured from the North). For example, a seismic ray-path may begin at the source (seismic shot point) S, traveling downward to be reflected from a formation surface at D, and then back up to be detected by receiver R. The reflected ray makes an angle θ with the normal to the reflecting surface or to the vertical since the reflector is assumed to be flat. Seismic data may be recorded by a receiver R for several different values of the source-receiver distance (called the offset), but each reflection event being from the same reflection point D. The receiver may measure seismic amplitude as a function of the two-way traveltime for the seismic wave to travel down to D from S and then back up to R. The traveltime is related to the depth of the reflection point by the geometry of the ray-path and the seismic wave velocity. This is illustrated, for example, in U.S. Pat. Nos. 7,761,237 and 8,706,420, both of which are incorporated by reference herein in their entirety. Due to this variability, it may be difficult to interpret and assign simple rules for classifying multiple reservoirs within a single seismic survey or across multiple surveys.

Further, in the context of inversion, priors may suffer from a simplistic estimate of the subsurface and a lack of geometric information. Specifically, priors for inversion may only include distributions of value devoid of geometric information and may be overly simplistic (e.g., only defining the subsurface as either shale/mud).

In contrast, in one or some embodiments, priors may include geometric information and one or more classifications of the subsurface (e.g., sand/shale; multiple types of sand/shale). Specifically, in one or some embodiments, a system and method are disclosed that enable users to create models that encapsulate complex rules that describe the distribution of AVO behaviors of sands and their sub-classes/rock types (e.g., high porosity, low porosity, calcite cemented) into a single probability volume, a multitude of probability volumes, or discrete classified volumes given known or assumed assemblages. In this regard, the initial models created may describe AVO behaviors of one or more subsurface features, thereby resulting in a dimensionality reduction of information, where numerous indicatorvolumes, e.g., AVO attributes, may have been used independently in the past. Resultant volumes may be used for geologic interpretation and/or as prior information for input into a seismic inversion process. This allows for the inversion to begin with geologically informed starting points which may be useful in scenario testing. The methodology may also be beneficial when more sophisticated inversion methodologies rely on classification in the loop and may reduce time spent on parameterization.

In this regard, the disclosed system and method may be configured to generate one or more initial geologic models for use in hydrocarbon management and/or in carbon sequestration. In one or some embodiments, the one or more initial geologic models may be directed to a plurality of scenarios that may occur in the subsurface. Example scenarios may comprise different distributions or compositions of sand and rocks in the subsurface. In practice, the one or more initial geologic models may be used in a variety of contexts. In one context, the initial geologic models may be used for initial well placement. For example, a respective geologic model may indicate the sections in the subsurface where the hydrocarbons may be present, which may then be used for the placement of any one, any combination, or all of the wells, the tubing, casing, piping, or the like. Alternatively, or in addition, a respective geologic model may be used for extraction, such as for primary depletion and/or enhanced oil recovery (EOR) (e.g., see U.S. Pat. No. 10,323,495, incorporated by reference herein in its entirety). In this context, the one or more initial geologic models may be used as part of a dynamic simulation for a respective stage of the hydrocarbon management process (e.g., for any one, any combination, or all of drilling and construction; primary depletion; or EOR) in order to use the initial geologic models in the respective stage of the hydrocarbon management process. Each respective stage of the hydrocarbon management process may have associated data, such as one or both of seismic data or production data. As such, both the initial geologic models and the associated data in order may be used to dynamically simulate at least one aspect in respective stage(s) of the hydrocarbon management process, such as the dynamic fluid flow (e.g., any one, any combination, or all of water, gas, or hydrocarbons) in the subsurface. Alternatively, or in addition, the one or more initial geologic models may be used as part of a dynamic simulation for a carbon sequestration process.

Further, in one or some embodiments, the initial geologic models may be modified or conditioned based on associated data. In particular, the associated data may be generated in the different stages of the hydrocarbon management process. In this regard, the initial geologic models may be updated or modified based on the associated data. As one example, the initial geologic models may comprise a range of scenarios (e.g., a plurality of sand probability volumes) for the subsurface. Responsive to receiving the associated data, the initial geologic models may be updated, such as modifying or narrowing the range of scenarios and potentially removing potential scenarios previously generated. As another example, the initial geologic models may be rebuilt responsive to the associated data (e.g., the production data) being indicative that the scenarios, as embodied in the initial geologic models, do not encompass the production data.

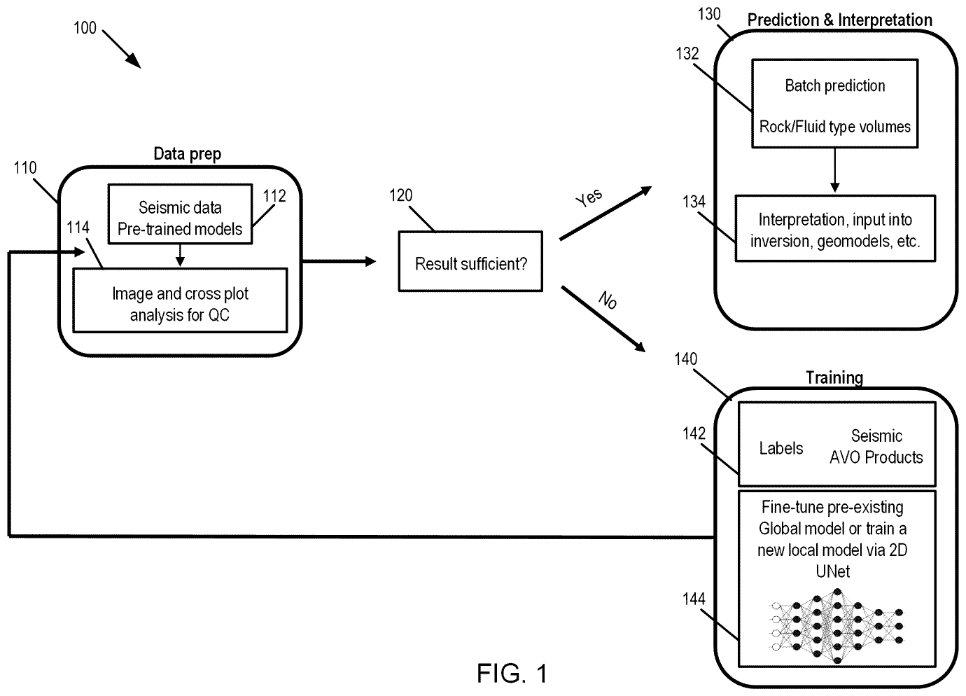

FIG. 1 illustrates a block diagram 100 for data preparation, training, and prediction and interpretation. Data prep 110 includes seismic data pre-trained models 112 and image and cross plot analysis for quality control (QC) 114. At 120, it is determined whether the result is sufficient (e.g., if there are a sufficient number of labels or is the model sufficiently trained). If not, training 140 is performed, including training by adding labels and through seismic AVO products 142. Various types of labels are contemplated, such as predictive labels (which may be used for batch prediction) or user-generated labels (which may be used for fine-tuning). Specifically, the seismic volumes may be identified as being most appropriate in the identification of various parts of the subsurface, such as reservoir/sand. In one or some embodiments, the identification may be manual. Alternatively, or in addition, the identification may be automatically performed dependent on training models configured for such identification. After which, labels may be generated that are representative of part(s) of the subsurface, such as representative of sand via cross-plot and visual analysis on seismic stacked volumes. In one or some embodiments, the labels may be generated manually and/or automatically.

At 144, the pre-existing global model may be fine-tuned or a new local model may be trained. For example, the training may be via a neural network, such as a convolutional neural network (e.g., 2D U-net). In particular, responsive to determining that the one or more potential subsurface models do not yield expected or desired results, one or both of the following may be performed: (i) generating additional labels or additional examples (see 142); and/or (ii) performing additional machine learning. Various forms of additional machine learning are contemplated, including any one, any combination, or all of: fine-tuning a general model (e.g., fine tuning the pre-existing global model); building and/or training a new local model; or retraining the general model with the labels (e.g., the local labels) included. After training 140, the flow may loop back to data prep 110 and/or to 120 (e.g., analyzing the one or more potential subsurface models for expected or desired results).

If at 120, the result is sufficient, prediction & interpretation 130 may occur, which may include batch prediction, such as rock/fluid type volumes 132, which may be used for interpretation and/or at 134 as input into (e.g., as a prior) inversion, geomodels, etc. As one example, 134 may comprise an input to a dynamic simulation. As discussed above, the dynamic simulation may be used for one or more stages of hydrocarbon management, such as during a drilling and construction phase (e.g., for placement of wells), a primary depletion phase, and/or an EOR phase. Alternatively, the dynamic simulation may be used for carbon sequestration.

Thus, in one or some embodiments, the system may determine whether the batch prediction of the part or all of the one or more reservoirs is within a predetermined tolerance of well data or predetermined interpretation need (e.g., predetermined interpretation resolution). If not (e.g., responsive to determining that the batch prediction of the part or all of the reservoir is not within the predetermined tolerance of the well data or the interpretation need), the system may revert back to at least one of 110 or 120 (e.g., analyzing the one or more potential subsurface models for expected or desired results).

In this regard, after prediction & interpretation 130, the system may again analyze whether the results are sufficient. See 120. Specifically, the analysis may focus on the models, whether in whole (e.g., the entire subsurface) and/or in part (a subpart of the subsurface), to determine whether the models are sufficient (e.g., the models may predict with sufficiency the subpart or the entire subsurface). Responsive to determining at 120 that the results are insufficient, the system may revert to training at 140.

In one or some embodiments, determining whether the results are sufficient 120 prior to performing prediction & interpretation 130 and after performing prediction & interpretation 130 may be different. Prior to performing prediction & interpretation 130 (e.g., after data prep 110), determining sufficiency 120 may comprise examining sufficiency of different parts of the models themselves (e.g., examining a specific subpart of the subsurface to determine whether the correct AVO behaviors are captured, such as in a specific line in the subsurface). In contrast, after preforming prediction & interpretation 130, determining sufficiency 120 may comprise examining sufficiency of different parts of the models with respect to each other (e.g., examining continuity of the different subparts to determine whether the correct AVO behaviors are captured consistently across the subparts of the subsurface, such as across different lines in the subsurface). In one or some embodiments, the models may predict in 2 dimensions (e.g., a slice of the subsurface) and/or in 3 dimensions (e.g., a volume in the subsurface). In either instance, determining sufficiency 120 may examine consistency across 2 or 3 dimensions. Merely as one example, determining sufficiency 120 may analyze the AVO crossplot (e.g., does the respective model's predictions of placing certain structures in the subsurface, such as the sand in the subsurface, make geologic sense when analyzing the AVO crossplot). In this regard, one measure of sufficiency may comprise using a crossplot scale that is spatially agnostic. As another example with regard to the crossplot, spatial context continuity may be examined along an inline (e.g., do the placed structure(s) make geologic sense along a 2-D plane). Still another example with regard to the crossplot, spatial context continuity may be examined in a volume (e.g., do the placed structure(s) make geologic sense in a 3-D volume). Thus, sufficiency may be examined with regard to the crossplot scale in any one, any combination, or all of being spatially agnostic; in a plane; or in a volume.

After determining that the batch prediction of the part or all of the reservoir is within the predetermined tolerance of the well data or the interpretation need, the batch prediction may be used for one or both of hydrocarbon management or carbon capture sequestration (CCS). As discussed above, hydrocarbon management may be represented in one or more stages. Further, CCS may be used to store carbon dioxide and/or as part of a stage of hydrocarbon management (e.g., in EOR). In this regard, the initial models generated may be used as part of the CCS process. For example, the initial models may be used to determine viability with regard to CCS (e.g., whether certain pressures may be attained and/or other predicted aspects related to the subsurface that are relevant to the CCS process).

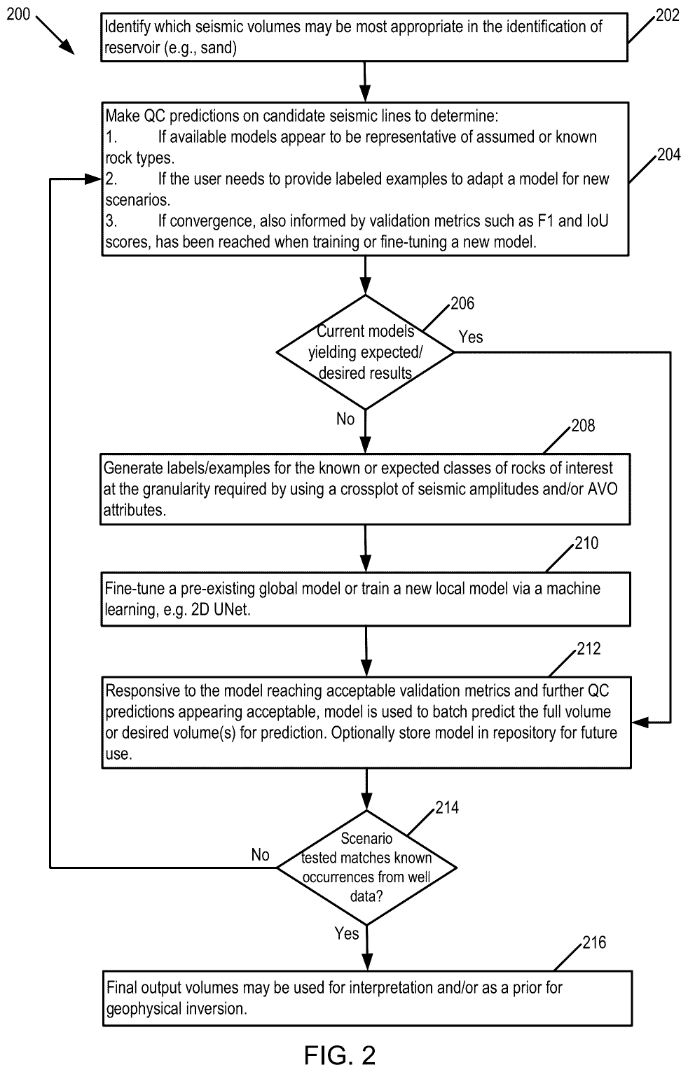

FIG. 2 is a flow diagram 200 for training and using models. At 202, the methodology identifies which seismic volumes may be most appropriate in the identification of the reservoir (e.g., sand). At 204, the methodology may have one or more QC predictions on candidate seismic lines to determine any one, any combination, or all of: (1) if available models appear to be representative of assumed or known rock types; (2) if the user needs to provide labeled examples to adapt a model for new scenarios; or (3) if convergence, also informed by validation metrics (e.g., F1 score and intersection over union (IoU) scores), has been reached when training or fine-tuning a new model.

At 206, the methodology determines whether the current models are yielding expected and/or desired results. This may be one example to determine whether the results are sufficient. If not, at 208, the methodology generates labels/examples for the known or expected classes of rocks of interest at the granularity required, such as by using a crossplot of seismic amplitudes and/or AVO attributes. At 210, the methodology fine-tunes a pre-existing global model or train a new local model via a machine learning (such as at 144). At 212, responsive to the model reaching acceptable validation metrics and further QC predictions appearing acceptable, the methodology uses the model to batch predict the full volume or desired volume(s) for prediction, and may store the model in a repository for future use. At 214, the methodology may determine whether the scenario tested matches known occurrences from well data. If not, flow diagram 200 loops back to 204. If so, at 216, the methodology uses the final output volumes for interpretation and/or as a prior for geophysical inversion.

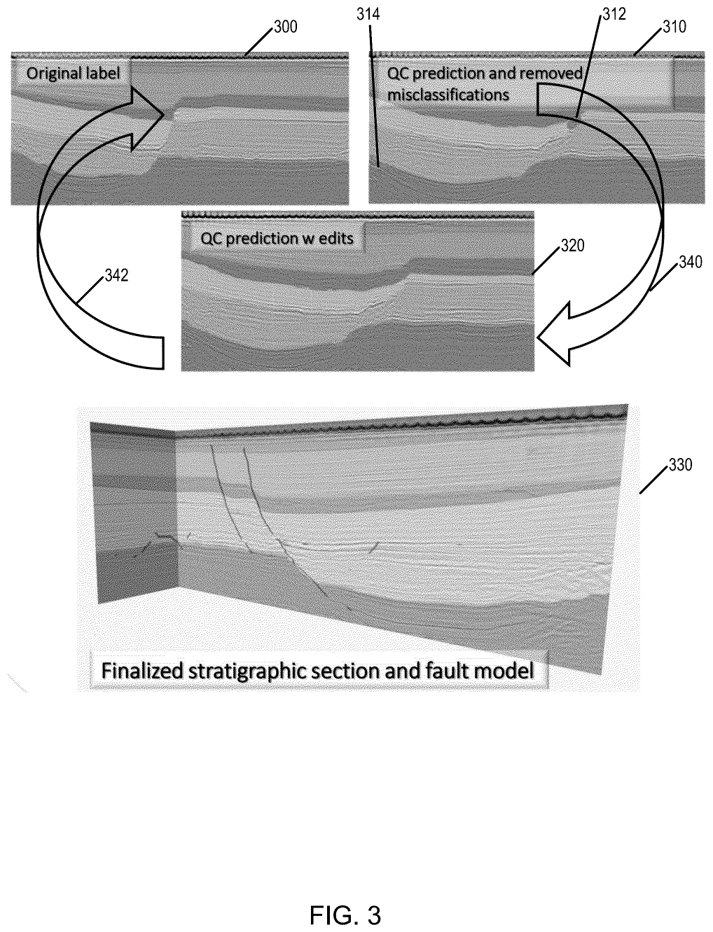

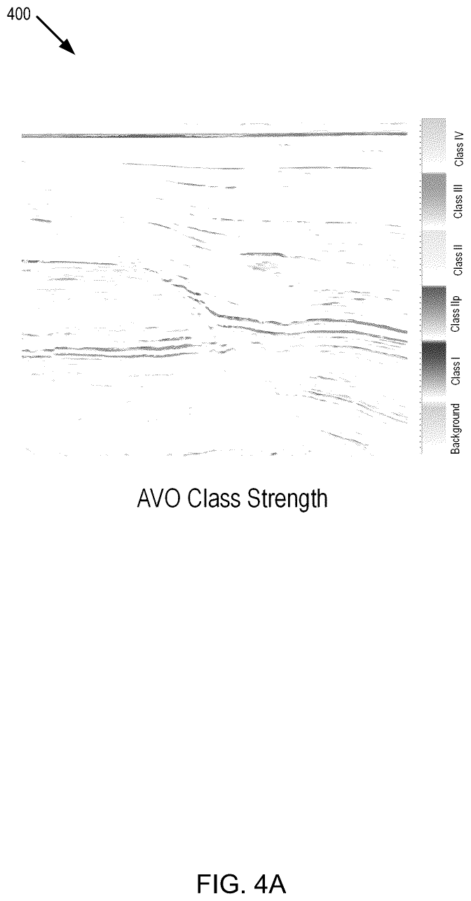

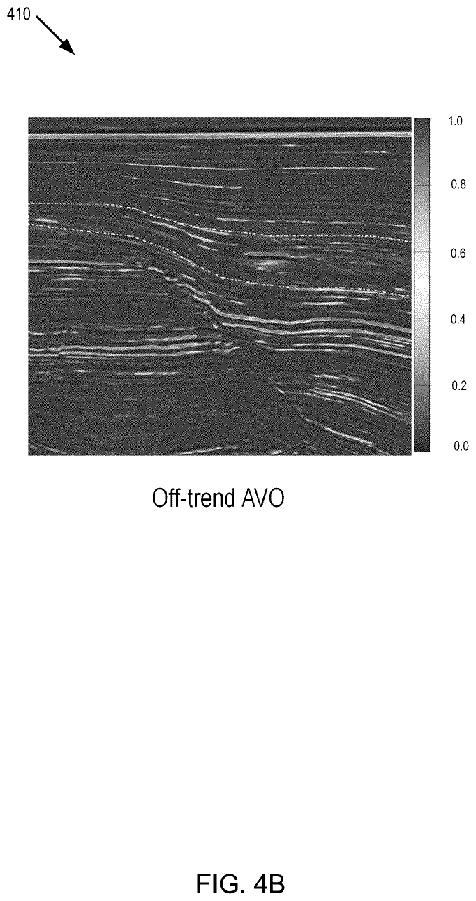

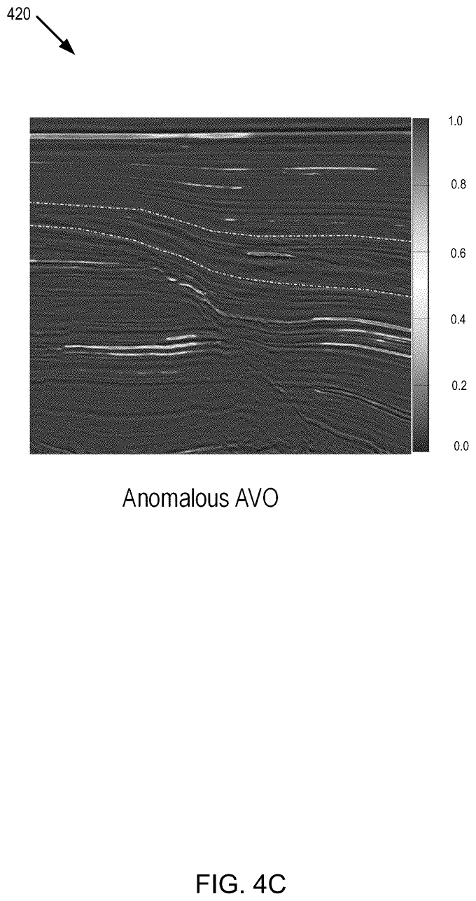

FIG. 3 are illustrations of stratigraphic segmentations and fault predictions. 300 is an illustration with an original label, 310 is an illustration of QC prediction and removed misclassifications (such as by human input, as discussed below), 320 is an illustration of QC prediction with the edits (such as made at 310), and 330 is an illustration of the finalized stratigraphic section and fault model after one or more iterations (illustrated by arrows 340, 342).

As discussed above, goals may include reducing the cycle time for outstanding seismic interpretation activities, allowing for the formal collection of examples to inform and automate future analyses, and augmenting broad integration practices. To create an integrated workflow that enables expert geoscientists to train models for various tasks, software may be used in order to build labeling capabilities, to enable, via a user interface, expert hyperparameter selection, model checkpoint selection, on demand QC predictions and editing tools, and batch prediction processing. In practice, an object storage service and database may be used for keeping track of data, labels, meta data, and models. Labeling (such as illustrated at 300) may be performed for one or more features in an image, such as any one, any combination, or all of: stratigraphic sections; salt; faults; or horizons. Multi-attribute analysis, such as AVO interpretation, may also be performed and may allow for classification of AVO class, identification of locally anomalous data points, rock type predictions and other multi-attribute designations.

Further, integrating human input into the process at one or more points may improve the modeling. For example, combining multiple labeling techniques with human in the loop for QC and the update process (e.g., at 310, where the human may remove misclassifications 312, 314) may accelerate research and applications and may allow for better assessment of the behavior of neural networks beyond simple validation and test metrics plots. Specifically, the established and packaged workflows may accelerate a number of interpretation exercises that are traditionally cumbersome and may allow for generalization of a number of other tasks.

Thus, in one implementation, the stratigraphic segmentation may be achieved, for example, by training with labeled lines predominantly in the crossline direction using an optimally parameterized network. In one example, less than 2 percent of the crosslines had labels by the end of the iterative process in which labels were predicted on unseen data, edited by the user, and then fed back into training. An even smaller portion of the inlines were used, mostly to assist in label correlations. Postprocessing (which need not be computationally expensive) may be applied to stabilize residual misclassifications in the prediction. Since the result is a simplified segmentation of the data, horizons may be extracted between these interfaces.

The fault prediction may be created by fine-tuning the pre-trained fault network. Similarly, a very small portion of the data need only be required to update this model, which may reach convergence and acceptable results in a small number of iterations (e.g., after 2 iterations of user updates). By using the disclosed methodology, fault sticks may be extracted while accelerating the construction of structural frameworks in situations where available solutions may struggle.

Various early generalized tasks may be related to AVO analysis. These tasks may be accelerated with appropriate labeling tools and strategy. In this regard, a number of automated AVO classification networks may be trained to accelerate common geophysical reconnaissance workflows. An example AVO classifications may comprise AVO class strength, which may help collapse multi-dimensional AVO observations into a single volume to help describe trends, with the classification cutoffs relative to background potentially shifting with changing background strength. In this way, automatic AVO class strength may combine classification of typical AVO classes of interest with the probability of AVO behaviors trending off of local background, which may vary laterally and vertically, and may provide a general local AVO strength indicator that is adaptive to local changes in background reflectivity and amplitude scale. An output of the trained AVO classification network for AVO class strength is shown in illustration 400.

Another example AVO classification comprises off-trend AVO, which is also adaptive to relative background and spans AVO strength in class 1, 2P, 2, 3, and 4. This may be useful in identifying various reservoirs, source rocks, and other lithologies. An output of the trained AVO classification network for off-trend AVO is shown in illustration 410. Still another example AVO classification comprises anomalous AVO model, which may be trained on datasets with known hydrocarbon accumulations. This attribute may also be adaptive to relative background strength. An output of the anomalous AVO model is shown in illustration 420. In one or some embodiments, some or all models may be fine-tuned as necessary with QC predictions and the interactive visualization tools.

Thus, AVO anomalies from datasets where known hydrocarbon accumulations exist may be labeled and incorporated into a network to provide a geophysical anomaly detector that highlights AVO anomalies of various AVO classes and local strengths, reducing false positives obtained by traditional methods, particularly in regions with calibration. Further, combinations of global and/or regionally trained models for geophysical reconnaissance may be trained for various purposes, for example, lithology identification, fluid identification, etc.

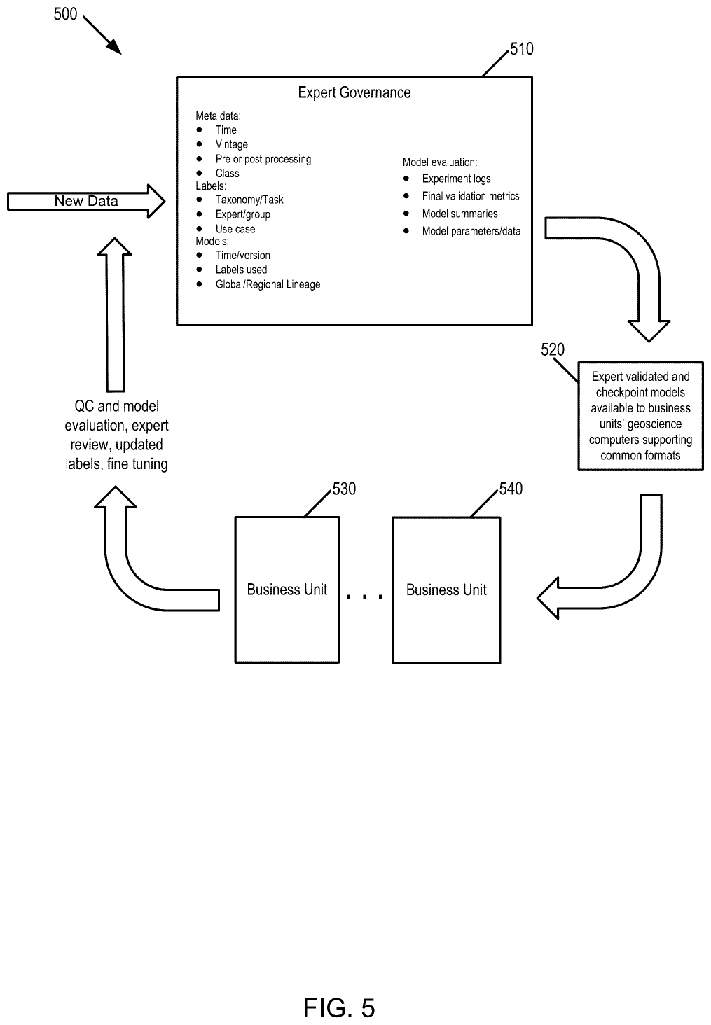

FIG. 5 is a block diagram 500 of data and model governance, wherein at one or more points, human intervention may be factored or input. The block diagram 500 includes expert governance 510, which receives as input new data and QC and any one, any combination, or all of: QC and model evaluation; expert review; updated labels; or fine tuning. Expert governance 510 may be configured to assign one or more of meta data (including any one, any combination, or all of: time; vintage; pre or post processing; or class), labels (including any one, any combination, or all of: taxonomy/task; expert/group; or use case), and models (including any one, any combination, or all of: time/version; labels used; or global/regional lineage). Further, the expert governance 510 may be configured to perform one or more tasks associated with model evaluation including any one, any combination, or all of: experiment logs; final validation metrics; model summaries; or model parameters/data.

One example of human intervention is in the form of expert validation at 520, where expert validated and checkpoint models are made available to geoscience computers supporting common formats of business units (including 530, 540). After which, another human intervention may occur in the form of expert review, and further QC and model evaluation, updated labels, and fine tuning.

In this way, the human intervention may be at discrete and limited points in the overall process. Due to the potential non-uniqueness of the seismic data and the large amount of variability present in and across datasets, one focus is to capture information related to the datasets available for training models, what the associated tasks are attempting to achieve, what models exist for users, and how those models were trained. Another focus is that models may be deployed for various applications with the associated information to assist with reconnaissance needs. With QC methods in software and the information associated with models, users may be able to check in their results and/or fine tune their models if needed. This data and the new examples may then be included into the growing repository with the models potentially being updated.

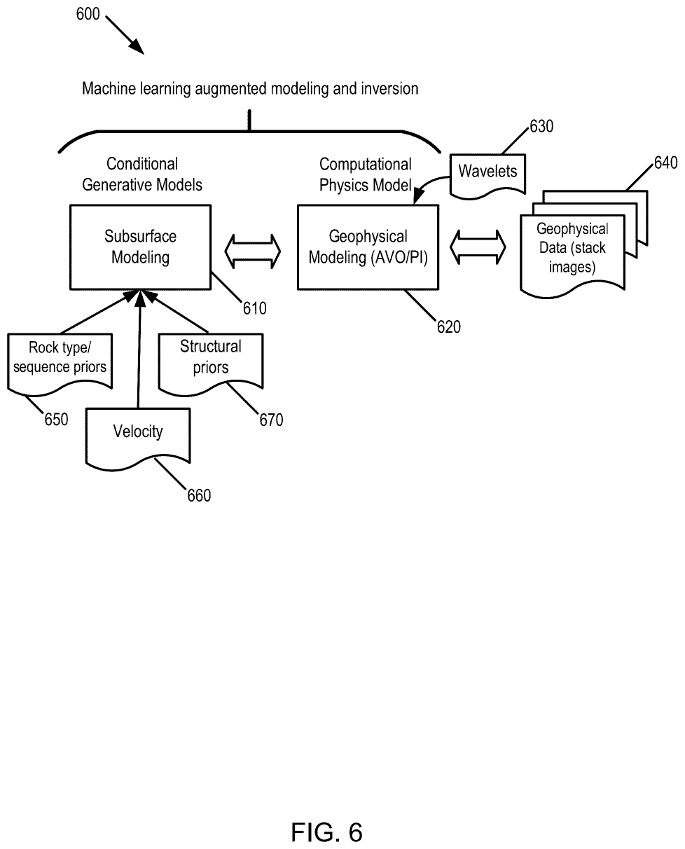

FIG. 6 is a block diagram 600 of machine learning augmented modeling and inversion. In one or some embodiments, rather than direct predictions of subsurface properties, one focus comprises better informing/augmenting the typical geophysical inversion process. As is known, the seismic data may be bandlimited in one, some, or all of the long wavelength, low frequency, and fine scale, and high frequency domains. Potential solutions have previously attempted to address bandlimit problem. In one or some embodiments, conditional priors from various applications (such as structural priors 670, including lithology) and known rock type and petrophysical distributions (e.g., rock type/sequence priors 650) along with velocity 660 may be linked with and used to train conditional generative models (subsurface modeling 610). In practice, subsurface training models may be conditionally stored within a neural network, such as a generative model. In turn, geophysical modeling (e.g., AVO/PI) 620 may comprise a computational physics model that inputs wavelets 630 and the subsurface modeling 610 in order to generate geophysical data 640 (e.g., stack images). Thus, a forward modeling operator and geophysical inversion scheme may inform the neural network to propose existing or new models that match some or all of the data provided. In this way, this hybrid approach may formally integrate aspects of the seismically conditioned geologic modeling process and reduce overall cycle time.

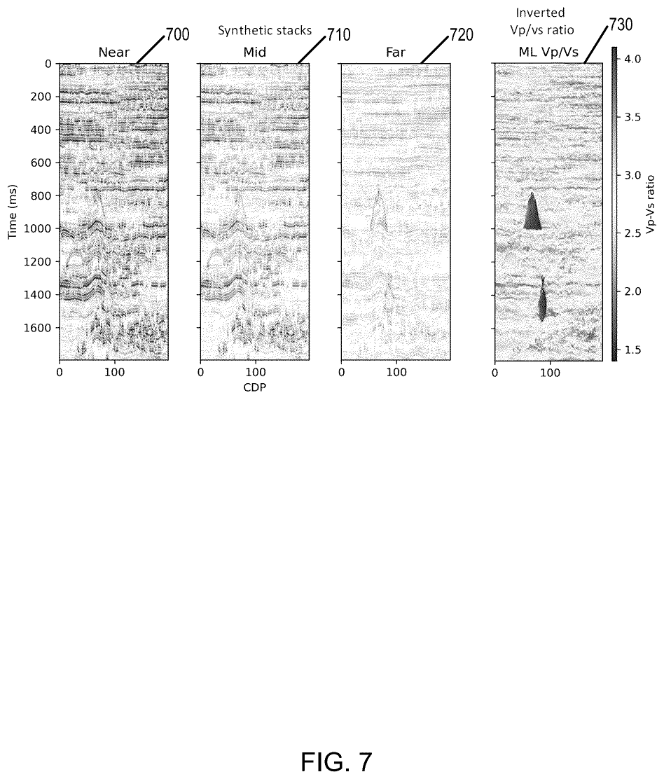

FIG. 7 illustrates a synthetic example in which this generative modeling and inversion process was performed to invert for Acoustic Impedance and Vp/Vs ratio using various angle stacks (including near 700, mid 710, and far 720). The obtained result 730 demonstrates the methodology's ability to fill in thick bodies and place fine scale features throughout the section and provide sharp interfaces.

In one or some embodiments, a deep learning framework may be built that performs any one, any combination, or all of: ingesting multiple common data formats; exposing multiple neural network architectures to researchers and users; and enabling easy modification of hyperparameter(s). These may include, for example, the number of classes and/or in a classification task, any one, any combination, or all of patch size, batch size, number of layers, number of filters, loss functions, or learning rate. Further, there may be quality control (QC) and batch prediction capabilities, which may be optimized for performance if the data format allows. Post-processing methods may also be available in order to improve prediction quality. In addition, since networks may be customized, methods, such as Bayesian optimization, may be used to tune hyperparameters for performance quality and time to convergence.

As discussed with regard to FIG. 7, a high performance computing environment may be used to train the models. In practice, customized software may communicate with a dedicated platform server, which may host a database and object store, and HPC storage. The database and object store may monitor the locations of data, stores labels, and other information. In practice, when jobs are requested from the customized software, the inputs from the user interface (UI) may be bundled up through the platform server and transmitted to one or more graphics processing unit (GPU) servers via a scheduler. In this way, one, some or all parameters may be communicated with the deep learning framework via a software tool in a way that is transparent to the end user.

Thus, in one or some embodiments, a 3D convolutional neural network may be trained for automatic fault detection. The training datasets may include, for example, one or more offshore basins. Further, in one or some embodiments geophysically mindful data augmentations may be used to account for variability across seismic data classes and vintages in order to help with generalization.

Alternatively, a 2D model may be trained that may function as a starting point for fine-tuning with sparse labels when results degrade. This may occur when: the seismic and/or the structural style/local geology drifts too much from the input datasets. In practice, the network may train in tens of minutes on top of the existing model, and a human may be integrated in the loop QC process via a software interface (as another way in which limited human input may guide the process). Further, a postprocessing workflow may optionally be integrated in the framework and software (as highlighted above with regard to FIG. 3), and may allow for merging of predictions in both directions and morphological thinning. In turn, the process may produce results that may be input to another that may yield fault planes that are generally less segmented than currently available methods.

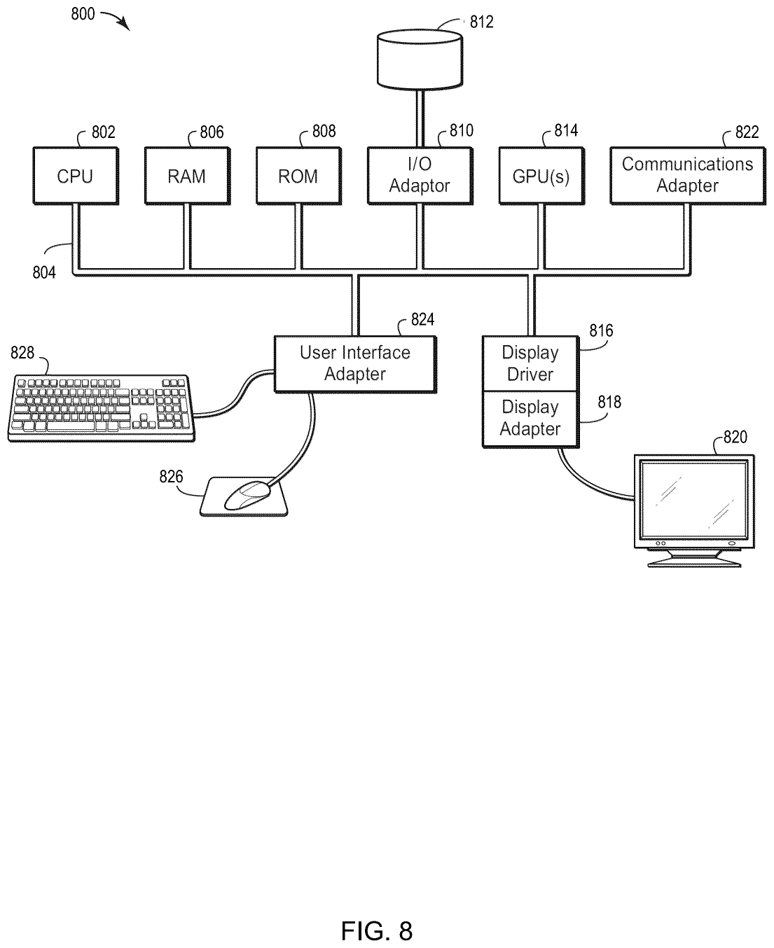

In all practical applications, the present technological advancement must be used in conjunction with a computer, programmed in accordance with the disclosures herein. For example, FIG. 8 is a diagram of an exemplary computer system 800 that may be utilized to implement methods described herein. A central processing unit (CPU) 802 is coupled to system bus 804. The CPU 802 may be any general-purpose CPU, although other types of architectures of CPU 802 (or other components of exemplary computer system 800) may be used as long as CPU 802 (and other components of computer system 800) supports the operations as described herein. Those of ordinary skill in the art will appreciate that, while only a single CPU 802 is shown in FIG. 8, additional CPUs may be present. Moreover, the computer system 800 may comprise a networked, multi-processor computer system that may include a hybrid parallel CPU/GPU system. The CPU 802 may execute the various logical instructions according to various teachings disclosed herein. For example, the CPU 802 may execute machine-level instructions for performing processing according to the operational flow described.

The computer system 800 may also include computer components such as non-transitory, computer-readable media. Examples of computer-readable media include computer-readable non-transitory storage media, such as a random-access memory (RAM) 806, which may be SRAM, DRAM, SDRAM, or the like. The computer system 800 may also include additional non-transitory, computer-readable storage media such as a read-only memory (ROM) 808, which may be PROM, EPROM, EEPROM, or the like. RAM 806 and ROM 808 hold user and system data and programs, as is known in the art. The computer system 800 may also include an input/output (I/O) adapter 810, a graphics processing unit (GPU) 814, a communications adapter 822, a user interface adapter 824, a display driver 816, and a display adapter 818.

The I/O adapter 810 may connect additional non-transitory, computer-readable media such as storage device(s) 812, including, for example, a hard drive, a compact disc (CD) drive, a floppy disk drive, a tape drive, and the like to computer system 800. The storage device(s) may be used when RAM 806 is insufficient for the memory requirements associated with storing data for operations of the present techniques. The data storage of the computer system 800 may be used for storing information and/or other data used or generated as disclosed herein. For example, storage device(s) 812 may be used to store configuration information or additional plug-ins in accordance with the present techniques. Further, user interface adapter 824 couples user input devices, such as a keyboard 828, a pointing device 826 and/or output devices to the computer system 800. The display adapter 818 is driven by the CPU 802 to control the display on a display device 820 to, for example, present information to the user such as subsurface images generated according to methods described herein.

The architecture of computer system 800 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 800 may include various plug-ins and library files. Input data may additionally include configuration information.

Preferably, the computer is a high-performance computer (HPC), known to those skilled in the art. Such high-performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft, Amazon.

The above-described techniques, and/or systems implementing such techniques, can further include hydrocarbon management based at least in part upon the above techniques, including using the AI model in one or more aspects of hydrocarbon management. For instance, methods according to various embodiments may include managing hydrocarbons based at least in part upon the one or more generated AI models and data representations constructed according to the above-described methods. In particular, such methods may include performing various welds in the context of drilling a well, and/or causing a well to be drilled, based at least in part upon the one or more generated geological models and data representations discussed herein (e.g., such that the well is located based at least in part upon a location determined from the models and/or data representations, which location may optionally be informed by other inputs, data, and/or analyses, as well) and further prospecting for and/or producing hydrocarbons using the well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

The following example embodiments of the invention are also disclosed:

### Embodiment 1

A computer-implemented method of performing geophysical investigation comprising:
(a) performing data preparation for one or more potential subsurface models by identifying one or more seismic volumes in determining one or more aspects of one or more reservoirs;
(b) analyzing the one or more potential subsurface models for expected or desired results;
(c) responsive to determining that the one or more potential subsurface models do not yield the expected or the desired results, performing one or both of: generating additional labels or additional examples; or performing additional machine learning, after which reverting to at least one of (a) or (b);
(d) using the one or more potential subsurface models to batch predict part or all of the one or more reservoirs;
(e) determining whether the batch prediction of the part or all of the one or more reservoirs is within a predetermined tolerance of well data or predetermined interpretation need;
(f) responsive to determining that the batch prediction of the part or all of the reservoir is not within the predetermined tolerance of the well data or the predetermined interpretation need, revert to at least one of (a) or (b); and
(g) responsive to determining that the batch prediction of the part or all of the reservoir is within the predetermined tolerance of the well data or the predetermined interpretation need, using the batch prediction for hydrocarbon management or carbon capture sequestration (CCS) management.

### Embodiment 2

The method of embodiment 1:
wherein analyzing the one or more potential subsurface models comprises performing quality control predictions on the one or more potential subsurface models.

### Embodiment 3

The method of embodiments 1 or 2:
wherein the quality control predictions on the one or more potential subsurface models comprises determining at least one of:
whether the one or more potential subsurface models are representative of assumed or known aspects including one or more of rock types, architectures, features, or facies;
whether additional labeled examples are used to adapt the one or more potential subsurface models for one or more new scenarios; or
whether convergence has been reached when training or fine-tuning a new potential subsurface model.

### Embodiment 4

The method of any of embodiments 1-3:
wherein responsive to determining that the one or more potential subsurface models yield the expected or the desired results, perform the batch prediction of (d) without performing (c).

### Embodiment 5

The method of any of embodiments 1-4:
wherein, responsive to determining that the one or more potential subsurface models do not yield expected or desired results, performing both of: generating the additional labels or the additional examples; and performing the additional machine learning, after which reverting to at least one of (a) or (b).

### Embodiment 6

The method of any of embodiments 1-5:
wherein performing the additional machine learning comprises one or more of: fine-tuning a general model; building a new local model; or retraining the general model with local labels included.

### Embodiment 7

The method of any of embodiments 1-6:
wherein performing the additional machine learning comprises each of: fine-tuning a general model; building a new local model; and retraining the general model with local labels included.

### Embodiment 8

The method of any of embodiments 1-7:
wherein analyzing the one or more potential subsurface models for expected or desired results analyzes subparts of at least one potential subsurface model; and wherein determining whether the batch prediction of the part or all of the one or more reservoirs is within a predetermined tolerance of the well data or the predetermined interpretation need analyzes across the subparts of the at least one potential subsurface model.

### Embodiment 9

The method of any of embodiments 1-8:
wherein determining whether the batch prediction of the part or all of the one or more reservoirs is within a predetermined tolerance of the well data or the predetermined interpretation need is based on an AVO crossplot.

### Embodiment 10

The method of any of embodiments 1-9:
wherein analysis with regard to the AVO crossplot for determining whether the batch prediction of the part or all of the one or more reservoirs is within a predetermined tolerance of the well data or the predetermined interpretation need is each of spatially agnostic, along at least one 2-D plane, and within a 3-D volume.

### Embodiment 11

The method of any of embodiments 1-10:
wherein the additional labels or the additional examples are generated using a crossplot of one or both of seismic amplitudes or AVO attributes.

### Embodiment 12

The method of any of embodiments 1-11:
wherein the additional machine learning comprises fine-tuning a pre-existing global model or training a new local model.

### Embodiment 13

The method of any of embodiments 1-12:
wherein generating the additional labels or the additional examples comprises a human removing misclassifications.

### Embodiment 14

The method of any of embodiments 1-13:
wherein prior to the human removing the misclassifications, quality control prediction is performed; and
wherein after the human removes the misclassifications, additional quality control is performed.

### Embodiment 15

The method of any of embodiments 1-14:
wherein the batch prediction is used for interpretation of a reservoir.

### Embodiment 16

The method of any of embodiments 1-15:
wherein the one or more potential subsurface models are used for dynamic simulation of fluid flow in a subsurface.

### Embodiment 17

The method of any of embodiments 1-16:
wherein the batch prediction is used for as a prior for geophysical inversion.

### Embodiment 18

The method of any of embodiments 1-17:
wherein using the batch prediction for hydrocarbon management comprises generating one or more priors for inversion based on the batch prediction; and
wherein human intervention is performed in order to modify the one or more priors in order to re-parameterize the inversion.

### Embodiment 19

The method of any of embodiments 1-18:
wherein, responsive to determining that the one or more potential subsurface models do not yield expected or desired results, the human intervention is iteratively performed in order to generate the additional labels or the additional examples.

### Embodiment 20

The method of any of embodiments 1-19:
wherein the human intervention is further used as assumptions about a reservoir regarding porosity and volume of clay.

### Embodiment 21

A system comprising:
a processor; and
a non-transitory machine-readable medium comprising instructions that, when executed by the processor, cause a computing system to perform a method according to any of embodiments 1-20.

### Embodiment 22

A non-transitory machine-readable medium comprising instructions that, when executed by a processor, cause a computing system to perform a method according to any of embodiments 1-20.

What is claimed is:

1. A computer-implemented method of performing geophysical investigation comprising:
(a) performing data preparation for one or more potential subsurface models by identifying one or more seismic volumes in determining one or more aspects of one or more reservoirs;
(b) analyzing the one or more potential subsurface models for expected or desired results;
(c) responsive to determining that the one or more potential subsurface models do not yield the expected or the desired results, performing one or both of: generating additional labels or additional examples; or performing additional machine learning, after which reverting to at least one of (a) or (b);
(d) using the one or more potential subsurface models to batch predict part or all of the one or more reservoirs;
(e) determining whether the batch prediction of the part or all of the one or more reservoirs is within a predetermined tolerance of well data or predetermined interpretation need;
(f) responsive to determining that the batch prediction of the part or all of the reservoir is not within the predetermined tolerance of the well data or the predetermined interpretation need, revert to at least one of (a) or (b); and
(g) responsive to determining that the batch prediction of the part or all of the reservoir is within the predetermined tolerance of the well data or the predetermined interpretation need, using the batch prediction for hydrocarbon management or carbon capture sequestration (CCS) management.

2. The method of claim 1, wherein analyzing the one or more potential subsurface models comprises performing quality control predictions on the one or more potential subsurface models.

3. The method of claim 2, wherein the quality control predictions on the one or more potential subsurface models comprises determining at least one of:
whether the one or more potential subsurface models are representative of assumed or known aspects including one or more of rock types, architectures, features, or facies;
whether additional labeled examples are used to adapt the one or more potential subsurface models for one or more new scenarios; or
whether convergence has been reached when training or fine-tuning a new potential subsurface model.

4. The method of claim 3, wherein responsive to determining that the one or more potential subsurface models yield the expected or the desired results, perform the batch prediction of (d) without performing (c).

5. The method of claim 1, wherein, responsive to determining that the one or more potential subsurface models do not yield expected or desired results, performing both of: generating the additional labels or the additional examples; and performing the additional machine learning, after which reverting to at least one of (a) or (b).

6. The method of claim 5, wherein performing the additional machine learning comprises one or more of: fine-tuning a general model; building a new local model; or retraining the general model with local labels included.

7. The method of claim 5, wherein performing the additional machine learning comprises each of: fine-tuning a general model; building a new local model; and retraining the general model with local labels included.

8. The method of claim 1, wherein analyzing the one or more potential subsurface models for expected or desired results analyzes subparts of at least one potential subsurface model; and
wherein determining whether the batch prediction of the part or all of the one or more reservoirs is within a predetermined tolerance of the well data or the predetermined interpretation need analyzes across the subparts of the at least one potential subsurface model.

9. The method of claim 8, wherein determining whether the batch prediction of the part or all of the one or more reservoirs is within a predetermined tolerance of the well data or the predetermined interpretation need is based on an AVO crossplot.

10. The method of claim 9, wherein analysis with regard to the AVO crossplot for determining whether the batch prediction of the part or all of the one or more reservoirs is within a predetermined tolerance of the well data or the predetermined interpretation need is each of spatially agnostic, along at least one 2-D plane, and within a 3-D volume.

11. The method of claim 1, wherein the additional labels or the additional examples are generated using a crossplot of one or both of seismic amplitudes or AVO attributes.

12. The method of claim 1, wherein the additional machine learning comprises fine-tuning a pre-existing global model or training a new local model.

13. The method of claim 1, wherein generating the additional labels or the additional examples comprises a human removing misclassifications.

14. The method of claim 13, wherein prior to the human removing the misclassifications, quality control prediction is performed; and
wherein after the human removes the misclassifications, additional quality control is performed.

15. The method of claim 1, wherein the batch prediction is used for interpretation of a reservoir.

16. The method of claim 1, wherein the one or more potential subsurface models are used for dynamic simulation of fluid flow in a subsurface.

17. The method of claim 1, wherein the batch prediction is used for as a prior for geophysical inversion.

18. The method of claim 1, wherein using the batch prediction for hydrocarbon management comprises generating one or more priors for inversion based on the batch prediction; and
wherein human intervention is performed in order to modify the one or more priors in order to re-parameterize the inversion.

19. The method of claim 18, wherein, responsive to determining that the one or more potential subsurface models do not yield expected or desired results, the human intervention is iteratively performed in order to generate the additional labels or the additional examples.

20. The method of claim 19, wherein the human intervention is further used as assumptions about a reservoir regarding porosity and volume of clay.
